(19) United States
(12) Patent Application Publication
(10) Pub. No.: US 2005/0216840 A1
(43) Pub. Date: Sep. 29, 2005

(54) In-timeline trimming

(76) Inventor: Keith Salvucci, Belmont, CA (US)

Correspondence Address: WONG, CABELLO, LUTSCH, RUTHERFORD & BRUCCULERI,;P.C., 20333 SH 249, SUITE 600, HOUSTON, TX, 77070, US

(21) Appl. No.: 10/809,903

(22) Filed: Mar. 25, 2004

(51) Int. Cl. G11B 27/00; G06F 3/00

(52) U.S. Cl. 715/723; 715/719; 715/720; 715/721; 715/722; 715/724; 715/725; 715/726; 715/833

(57) ABSTRACT

Disclosed herein is a graphical user interface for media file editing software designed to be used on a general purpose computer. The interface provides improved features for trimming or extending the length of media segments and time shifting the resulting segments to form a video composition.

### BACKGROUND

The invention relates generally to video editing software, and more particularly to a graphical user interface for video editing software. Historically editing of video images has been limited to professional production companies using extremely expensive equipment. This was in part because the significant computational power necessary to perform editing of video images has been prohibitively expensive for the consumer market. Because the market for video editing equipment, e.g., video editing software, has been comprised almost entirely of professionals, it has historically been very feature rich, but also encumbered with correspondingly sophisticated user interfaces.

Recently, innovations in computing power of personal computers has combined with reduced costs for such systems and availability of consumer-grade digital video cameras to put professional-grade video editing within the capability of consumer-oriented personal computers and relatively inexpensive hardware/software combinations. Although the computational power necessary to perform video editing has been made available to the consumer, the historic problems with excessive user interface complexity has prevented wide-spread adoption of video editing hardware and software for the personal computer targeted at the consumer market. Thus, it would be beneficial to provide video editing software and/or a video editing software hardware combination with a greatly simplified user interface to enable a typical consumer to produce professional-grade video using inexpensive, general-purpose computers.

### SUMMARY

The present invention relates to a graphical user interface. More particularly, the present invention relates to a graphical user interface for media file editing software designed to be used on a general purpose computer. The interface provides improved features for trimming or extending the length of media segments and time shifting the resulting segments to form a video composition.

In particular, a graphical user interface provides an iconographic timeline representing a media composition, the composition comprising a number of media segments. When a cursor is positioned adjacent an endpoint of one of the segments, a click-and-drag operation allows the user to extend or trim the length of a segment. Depending on whether one or more optional modes are entered, the segments may either be moved to accomplish the trimming or extension or may be overwritten or collapsed.

### BRIEF DESCRIPTION OF THE DRAWINGS

FIG. 1A illustrates creation of an audio/video media file.

FIG. 1B illustrates the transfer of an audio/video media file to a personal computer.

FIG. 2A illustrates a graphical user interface for a media file editing program in accordance with the teachings of the present disclosure.

FIG. 2B illustrates an enlarged view of a portion of the user interface of FIG. 2A.

FIG. 3A illustrates various aspects of a graphical user interface configured to accomplish a trimming or extending operation on a media file in accordance with the teachings of the present disclosure.

FIG. 3B further illustrates additional aspects of a graphical user interface configured to accomplish a trimming or extending operation on a media file in accordance with the teachings of the present disclosure.

FIG. 4 illustrates still further aspects of a graphical user interface configured to accomplish a trimming or extending operation on a media file in accordance with the teachings of the present disclosure.

### DETAILED DESCRIPTION

A graphical user interface to a video editing software program for use on a general purpose personal computer is described herein. The following embodiments of the invention, described in terms applications compatible with computer systems manufactured by Apple Computer, Inc. of Cupertino, Calif., are illustrative only and should not be considered limiting in any respect. Additionally, while the invention is described with regard to a video editing, it is applicable to any type of media editing, including video files, audio files, and audio-video files. As used herein, the term media should be understood to include each of these types of files and their equivalents.

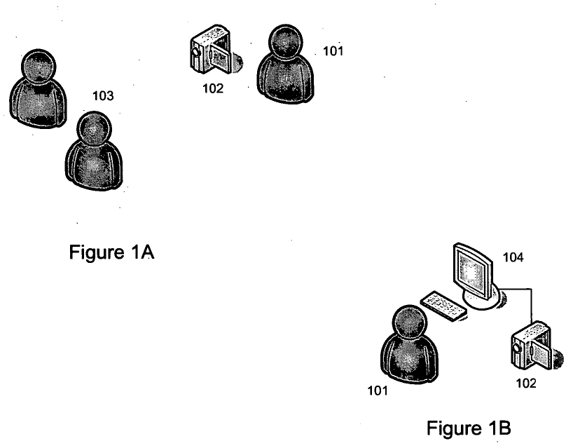

With reference to FIG. 1A, a user 101 uses a video camera 102 to record video images of a scene 103. Video camera 102 may be any type of video camera, although it is preferably a consumer-oriented video camera and more preferably a consumer-oriented video camera that records images in a digital format. Subsequently, as indicated in FIG. 1B, user 101 connects the video camera 102 to a personal computer 104 for the purpose of transferring the recorded video images from the video camera to the personal computer. Personal computer 104 is preferably one of various types manufactured by Apple Computer, Inc., although the graphical user interface described herein may be used with other computer types. If video camera 102 is a type that records images in a digital format, and it is equipped with an output port compatible with an input port on the computer, e.g., IEEE 1394 a/k/a “Firewire”, the video data may be transferred to the computer exactly as recorded. Alternatively, if video camera 102 records images in one of various traditional analog formats, e.g., VHS or its derivatives, personal computer 104 may be equipped with some sort of video capture device, for example a video capture peripheral card, that will capture the video data from the camera and store it on the computer in a digital format suitable for further processing by the computer. Various techniques and devices for transferring video images from a video camera to a computer are known to those skilled in the art, and it is contemplated that any of them may be used in accordance with the system described herein.

Once loaded on the personal computer, recorded video may be edited, stored on the computers hard disk drive, or copied to another medium for storage or for replay on another device. Media to which the video may be copied include, for example, digital versatile disk (DVD) or video compact disk (VCD or SVCD). Additionally, combinations are also contemplated, e.g., the video may be edited on the personal computer and the edited video may then be copied to a DVD for storage and replay on another device.

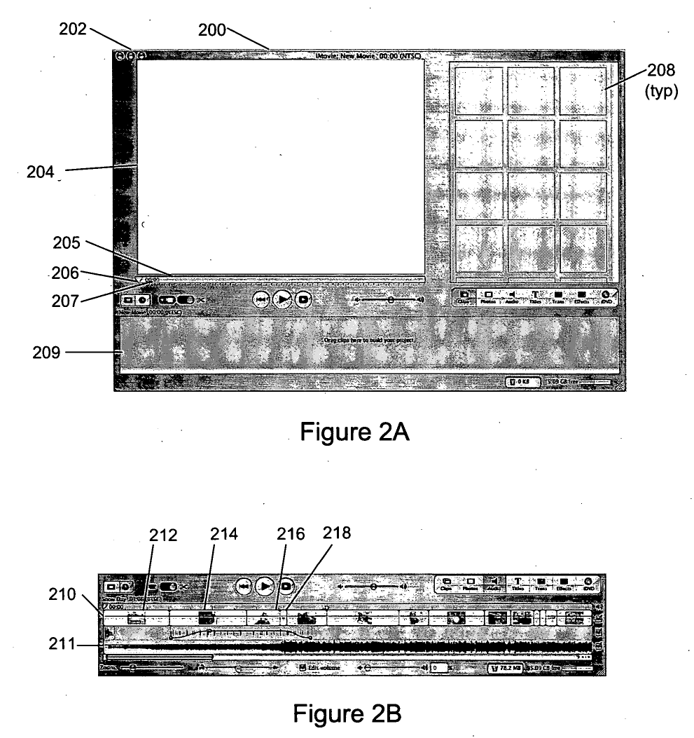

Turning now to FIG. 2A, a screen image from video editing software in accordance with the present invention is illustrated. Main window 200 comprises the visual portion of the user interface to the video editing software. As typically found in computer systems having graphical user interfaces, window control “buttons” 202 allow the user to maximize, minimize, or close main window 200. A composition window or monitor 204 is used to view the current video composition, i.e., the product of the video editing process. A scrubber bar 205 allows the user to move through a clip or composition, either frame by frame or on a faster basis. Such operation is preferably accomplished by a “click-and-drag” operation. Playhead 206 indicates the location of the currently displayed image within the composition, both by its relative left-to-right position on the scrubber bar 205 and by the numerical time readout 207 located adjacent the playhead.

A video composition is comprised of video clips, which would be shown in individual windows 208. Although the clip windows 208 in FIG. 2A are shown empty, for convenience, video clips will also be referred to using reference 208. A video clip is a sequence of video (and corresponding audio) data, for example, a sequence transferred from the video camera. A composition may include from one to any number of individual video clips, although typically the composition will include multiple clips. Video clips 208 may be combined sequentially to form the composition by placing them in the desired order in timeline 210 (FIG. 2B), which may preferably be accomplished by a “drag and drop” operation. As indicated in FIG. 2B, the current video composition comprises video clips 212, 214, 216, and 218, as well as additional unnumbered clips. FIG. 2B is an enlarged view of region 209 shown in FIG. 2A.

The timeline also includes an audio region 211, which displays in graphical form the audio content of a clip displayed in the timeline.

Editing a composition is a process that generally includes at least the following: (1) selecting one or more clips that will make up the composition, (2) placing these clips in the desired order, and (3) adjusting the clips to remove unwanted material and/or make them the desired length, for example, by trimming material from the beginning and/or end of the clip. The graphical user interface simplifies operation No. 3 of this process by simplifying the process of “trimming” the clips. As a matter of terminology, “trimming” the clips means removing selected frames, for example, removing frames at the beginning or ending portion of a clip. “Cropping” a clip refers to preserving a selected portion of a clip and removing the frames before and after the selected portion. It also bears noting that a clip may preferably be split apart into one or more pieces, thereby creating additional ends, which can then also be trimmed or cropped.

Historically, trimming or cropping a clip required the user to select the clip to be trimmed. The user would then position trim markers on a scrubber bar to delimit the beginning and endpoint of the trimmed clip. However, a new, more efficient method of accomplishing this task is described below.

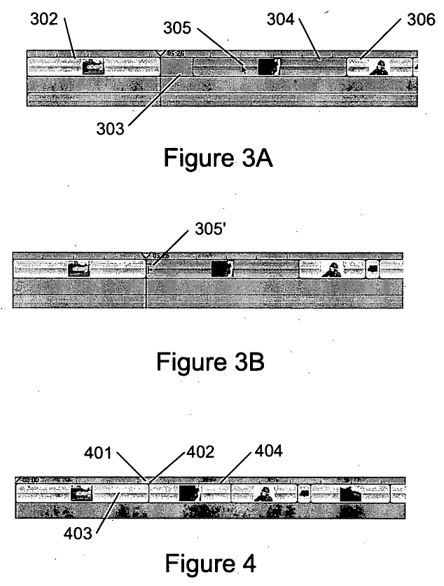

An illustration of the timeline is illustrated in FIG. 3A. A first clip 302, a second clip 304, and a third clip 306 are illustrated. Additionally, there is a gap 303 between the end of clip 302 and clip 304, while the end of clip 304 is directly against the beginning of clip 306. A pointer or cursor 305 is also illustrated. If the cursor 305 is positioned over the ends of one of the clips, cursor 305 changes its appearance, to arrow 305′, as is illustrated in FIG. 3B. The cursor 305′ users a horizontal arrow as an affordance, indicating to the user that horizontal movement is possible. Particularly, this is indicating that the beginning point or left-most endpoint of clip 304 may be moved to the right, effectively shortening the clip by deleting material from the beginning of the clip.

If the user clicks the mouse and drags it horizontally, the edge of the clip extends or shortens. If you are hovering over the left edge of the clip and click and drag left, the clip extends, i.e., more material from the beginning of the clip is included in the composition. Similarly, if you are hovering over the right edge of a clip (the end) and click and drag to the left, when you drag to the right it shortens the clip. If you instead move to the right, the clip is extended. In all cases, when the clip is being extended, it will automatically stop extending when the end of the file is reached.

Preferably, the cursors change depending on which end of the clip you are trimming and whether or not you can trim in a certain direction. The ability to trim is limited by the amount of media currently being represented by the clip, compared to what is available in the clip's media file. As an example, if you are trimming the beginning of a clip and the cursor is pointing only to the right, as indicated by cursor 305′ in FIG. 3B, this means that clip 304 can only be trimmed to the right. The clip is already showing the beginning of the file. Alternatively, if a bi-directional arrow cursor is shown, this indicates that you can trim in both directions. Going to the left would allow you to extend the clip and show the rest of the media available at the beginning of the file, while going to the right would shorten the clip by truncating media at the beginning of the file.

As shown in FIG. 4, additional indication of what trimming operations may be performed is indicated by the representations of the clips themselves in the timeline. In a preferred embodiment, untrimmed edges of clips have rounded corners as with corners 401 of clip 403 indicating that the composition includes media all the way to the end (or beginning) of the clip file. Alternately, trimmed clips have 90-degree angled corners as with corners 402 of clip 404. Media that is trimmed from the end of a clip is not played in the composition and not shown in the timeline view once it is trimmed. In a preferred embodiment, material that is trimmed from a clip is kept in a recycle bin or buffer so that the trimming option may be undone by restoring the trimmed material.

In general, when material is trimmed from a clip, the remaining clips in the composition are moved to fill the empty space left by the trimming operation. This is known as rippling. When a clip is trimmed, all downstream clips will shift earlier in the composition time by the amount trimmed so that there is no gap in the composition. However, an alternate function is available for trimming. For example, holding down a command key while performing the trimming operation may turn off rippling and perform an overwrite edit. Thus if the command key is held down while extending a trimmed clip to a location where a different clip already exists, the extended clip overwrites the overlapping portion of the destination clip. Because of the overwrite, there is effectively no ripple. Alternatively, if the command key is held down while trimming, blank space is inserted to preserve the location of the clip and all downstream clips. Once again, no ripple occurs. In short, one interface mode (for example a simple click-and-drag operation) provides for rippling (i.e., time shifting) when trimming or extending a clip. An alternative interface mode (for example, a click-and-drag while holding a command key) provides for preserving the location in time of clips while trimming or extending.

It is also preferable to provide another mode for the trimming or extending operation. For example, holding down an option key may provide “audio scrubbing” while a clip is trimmed or extended. Audio scrubbing plays through the audio track corresponding to the video being edited so that the endpoints of a trimming or extending operation may be placed with reference to a particular event on the audio track. For example, it might be desirable to trim a video clip to include only the portion in which a person is speaking. This additional interface mode, i.e., the click-and-drag while holding down an option key allows a dip to be trimmed and/or extended to an accurate location within the media composition aurally (and visually). Using prior video editing software interfaces, this type of operation would normally require several cumbersome editing steps.

While the invention has been disclosed with respect to a limited number of embodiments, numerous modifications and variations will be appreciated by those skilled in the art. It is intended that all such variations and modifications fall with in the scope of the following claims.

1. A method for editing an media file comprising one or more media segments, using software designed for use on a general-purpose computer, the software having a graphical user interface comprising a cursor and an iconographic timeline indicating different locations within the file, the method comprising:
receiving from a user interface signals corresponding to positioning the cursor over the timeline in a position corresponding to an endpoint of a media segment;
receiving from the user interface signals corresponding to grabbing and moving the endpoint within the timeline; and
changing the length of the media segment in response to the movement of the endpoint within the timeline.

2. The method of claim 1 further comprising displaying an iconographic affordance indicating available directions for moving the endpoint.

3. The method of claim 2 wherein the affordance comprises an arrow.

4. The method of claim 1 wherein an iconographic representation of the endpoint changes to indicate whether the segment length may be changed.

5. The method of claim 4 wherein the iconographic representation of the endpoint comprises squared edges to indicate that the segment has been trimmed.

6. The method of claim 4 wherein the iconographic representation of the one or more endpoints comprises rounded edges to indicate that the segment has not been trimmed.

7. The method of claim 1 further comprising:
displaying representative frames corresponding to the audio video segment endpoint.

8. The method of claim 1 wherein the media file is an audio/video file.

9. The method of claim 1 wherein the media file is an audio file.

10. The method of claim 1 wherein the media file is a video file.

11. A computer readable medium, having disposed thereupon program instructions for a general purpose computer, the instructions configured to allow the computer to perform media file editing, the media file editing comprising the steps of:
receiving from a user interface signals corresponding to positioning the cursor over the timeline in a position corresponding to an endpoint of a media segment;
receiving from the user interface signals corresponding to grabbing and moving the endpoint within the timeline; and
changing the length of the media segment in response to the movement of the endpoint within the timeline.

12. The computer readable medium of claim 11 further comprising displaying an iconographic affordance indicating available directions for moving the endpoint.

13. The computer readable medium of claim 11 wherein the affordance comprises an arrow.

14. The computer readable medium of claim 11 wherein an iconographic representation of the endpoints changes to indicate whether the segment length may be changed.

15. The computer readable medium of claim 14 wherein the iconographic representation of the endpoint comprises squared edges to indicate that the segment has been trimmed.

16. The computer readable medium of claim 14 wherein the iconographic representation of the one or more endpoints comprises rounded edges to indicate that the segment has not been trimmed.

17. The computer readable medium of claim 11 further comprising:
displaying representative frames corresponding to the audio video segment endpoint.

18. The computer readable medium of claim 11 wherein the media file is an audio/video file.

19. The computer readable medium of claim 11 wherein the media file is an audio file.

20. The computer readable medium of claim 11 wherein the media file is a video file.

21. A graphical user interface for a media editing program executed by a general purpose computer, the graphical user interface comprising:
a cursor;
an iconographic timeline, wherein the cursor may be movably positioned along the iconographic timeline; and
an iconographic illustration of one or more endpoints of a media segment, the endpoints being located along the timeline, wherein the cursor changes appearance when positioned proximate an endpoint of the media segment to indicate that a length of the media segment may be changed.

22. The graphical user interface of claim 21 wherein the cursor changes appearance to an arrow indicating one or more directions in which the endpoint of the media file may be moved, the movement of the endpoint corresponding to a change in the length of the media segment.

23. The graphical user interface of claim 21 wherein the iconographic representation of the one or more endpoints changes to indicate whether the segment length may be changed.

24. The graphical user interface of claim 3b wherein the iconographic representation of the one or more endpoints includes squared edges to indicate that the segment has been trimmed.

25. The graphical user interface of claim 3b wherein the iconographic representation of the one or more endpoints includes rounded edges to indicate that the segment has not been trimmed.

26. The graphical user interface of claim 21 further comprising:
at least one representation of media corresponding to the endpoint.

27. The graphical user interface of claim 21 wherein the media segment is an audio/video file.

28. The graphical user interface of claim 21 wherein the media segment is an audio file.

29. The graphical user interface of claim 21 wherein the media segment is a video file.
